(19) United States
(12) Patent Application Publication
(10) Pub. No.: US 2019/0041616 A1
(43) Pub. Date: Feb. 7, 2019

(54) WIDE ANGLE LENS AND WIDE ANGLE CAMERA COMPRISING SAME

(71) Applicant: RAYCOLL, Gyeongsangnam-do (KR)

(72) Inventor: Eun Jin Jeong, Gyeongsangnam-do (KR)

(73) Assignee: RAYCOLL, Gyeongsangnam-do (KR)

(21) Appl. No.: 16/074,888

(22) PCT Filed: Jan. 24, 2017
(86) PCT No.: PCT/KR2017/000798

§ 371 Date: Aug. 2, 2018

(30) Foreign Application Priority Data
Feb. 15, 2016 (KR) 10-2016-0017186

(51) Int. Cl. G02B 13/06; H04N 5/225; H04N 7/18; G02B 13/00

(52) U.S. Cl. CPC G02B 13/06; G02B 13/001; H04N 7/18; H04N 5/2254

(57) ABSTRACT

A wide-angle lens for condensing light from a subject, wherein the wide-angle lens is a convex lens having all types of continuous focuses generated by tracing a line segment with respect to one axis and then rotating the line segment with respect to the axis. The wide-angle camera includes a lens for condensing light from a subject; and an image sensor, disposed at a focal length of the lens, for outputting, as electrical signals, an image generated by the light which has passed through the lens, wherein the lens is a convex lens having all types of continuous focuses generated by tracing a line segment with respect to one axis and then rotating the line segment with respect to the axis, and the image sensor is formed to have a curved surface so as to correspond to the focal length of the lens.

### TECHNICAL FIELD

The present disclosure relates to a wide view angle lens which is applicable to a Closed-Circuit TV (CCTV) camera or the like, and a wide view angle camera including the lens and, more particularly, to a lens and a camera capable of obtaining a distortion-free wide view angle image without performing software processing.

### BACKGROUND ART

In general, a camera is a device that condenses light, reflected from a subject, through a lens so as to fix an image at a specific position. Recently, digital cameras, in which a film in the structure of the first camera is replaced with a digital image sensor, have been widely used. Referring to FIG. 1, the structure of a general digital camera can be easily understood.

Meanwhile, it is desirable that a CCTV camera used for security can monitor a wide area using one camera. In order to achieve such a purpose, a camera used for monitoring may employ a wide-angle lens such as a fisheye lens. However, an image obtained through a fisheye lens has problem in that it is severely distorted. Meanwhile, another example of a camera structure for achieving the purpose of wide view angle photographing is disclosed in Korean Laid-Open Patent Publication No. 2013-0037883.

The laid-open patent adopts a structure in which a wide range of light can be condensed into a camera using a reflection structure on a camera lens so that a wide range can be photographed. Such a conventional wide view angle camera has an advantage in that it can photograph a wide range, but has a problem in that a photographed image is distorted, as a fatal disadvantage. Therefore, since it is necessary to add an image processing module for correcting an image distorted as described above, the camera is structurally complicated, and image processing time is required, which causes delay in the photographing time and the final image output time. In addition, since the image processing module is added, the manufacturing cost of the camera increases.

### DETAILED DESCRIPTION OF THE INVENTION

### Technical Problem

The present disclosure has been made in order to solve the problems described above, and an objective of the present disclosure is to provide a wide view angle lens and a wide view angle camera, in which the structure of the wide view angle lens is improved such that a photographed image is not distorted and wide view angle photographing is enabled.

### Technical Solution

In order to achieve the above-described objective, a wide view angle lens according to an embodiment of the present disclosure is a wide view angle lens configured to condense light from a subject.

The lens is a convex lens having all types of continuous focal points formed by drawing a line segment with respect to one axis and rotating the line segment with respect to the axis.

### Advantageous Effects

The wide view angle lens according to the present disclosure is configured such that a focused image is formed on a curved face, and a wide view angle camera including the lens is provided with an image sensor corresponding to a curved face of the image formed by the lens. Accordingly, there is provided an effect of providing a camera capable of implementing wide view angle photographing in an innovative manner.

### BRIEF DESCRIPTION OF THE DRAWINGS

FIG. 1 is a view showing a principle of a general digital camera;

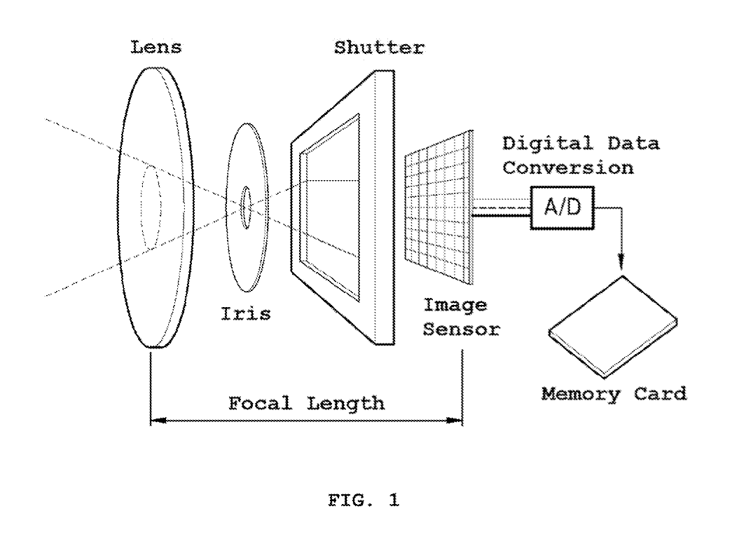

FIG. 2 is a view showing a principle in which a cylinder lens forms an image;

FIG. 3 is a view showing an example of an arrangement of a lens and an image sensor in a camera according to a first embodiment of the present disclosure;

FIG. 4 is a view seen in a “Z” direction shown in FIG. 3;

FIG. 5 is a sectional view taken along line V-V in FIG. 3;

FIG. 6 is a view showing a modified structure of the first embodiment;

FIG. 7 is a view showing an arrangement of an image sensor in a camera structure according to a second embodiment of the present disclosure;

FIG. 8 is a plan view of the camera structure shown in FIG. 7;

FIG. 9 is a view showing an arrangement of an image sensor in a camera structure according to a third embodiment of the present disclosure; and

FIG. 10 is a view showing a modified structure of the third embodiment.

### MODE FOR CARRYING OUT THE INVENTION

Hereinafter, embodiments of the present disclosure will be described in detail with reference to the accompanying drawings.

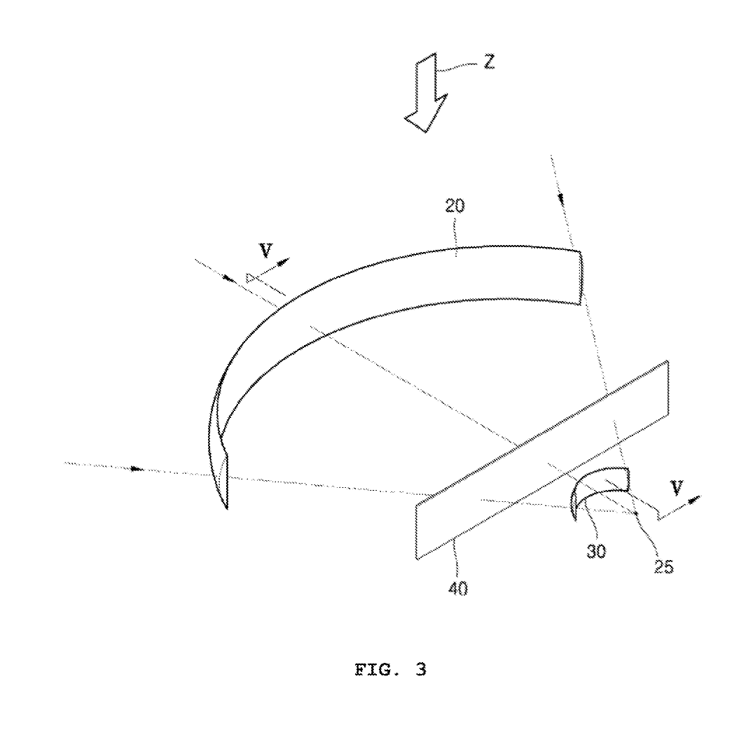

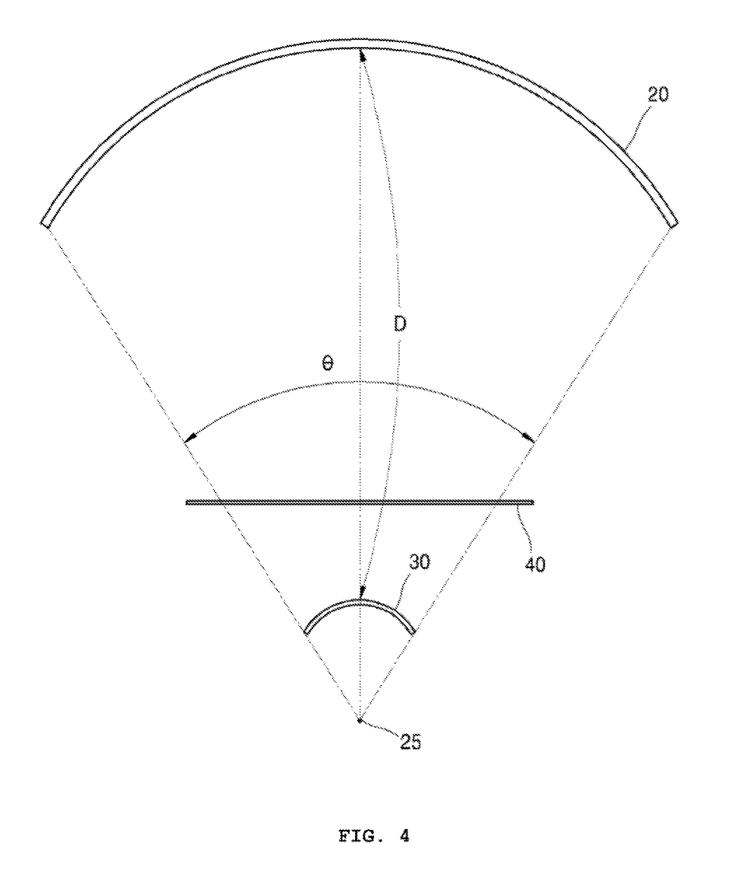

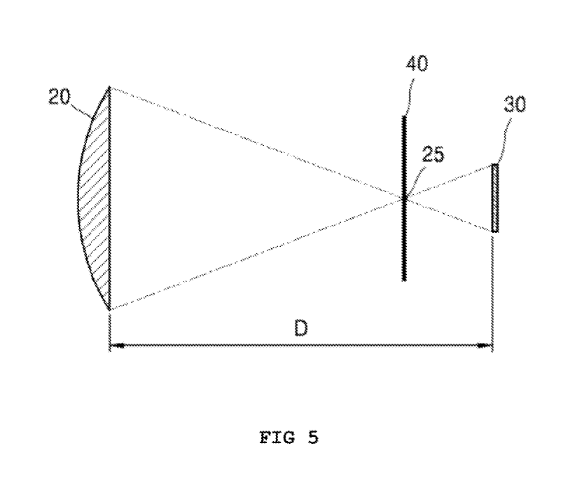

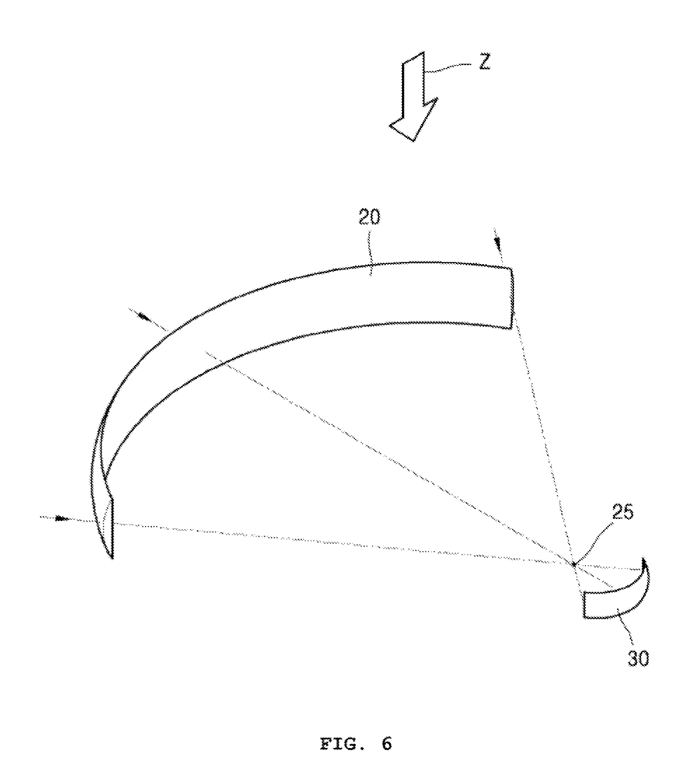

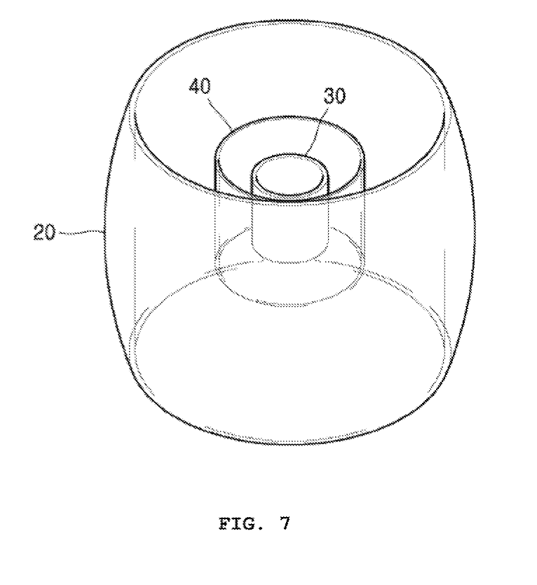

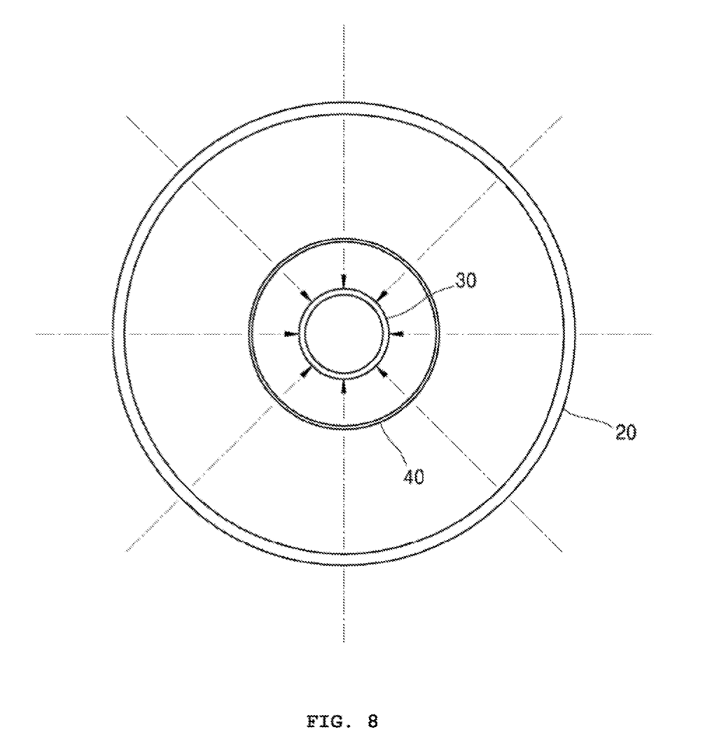

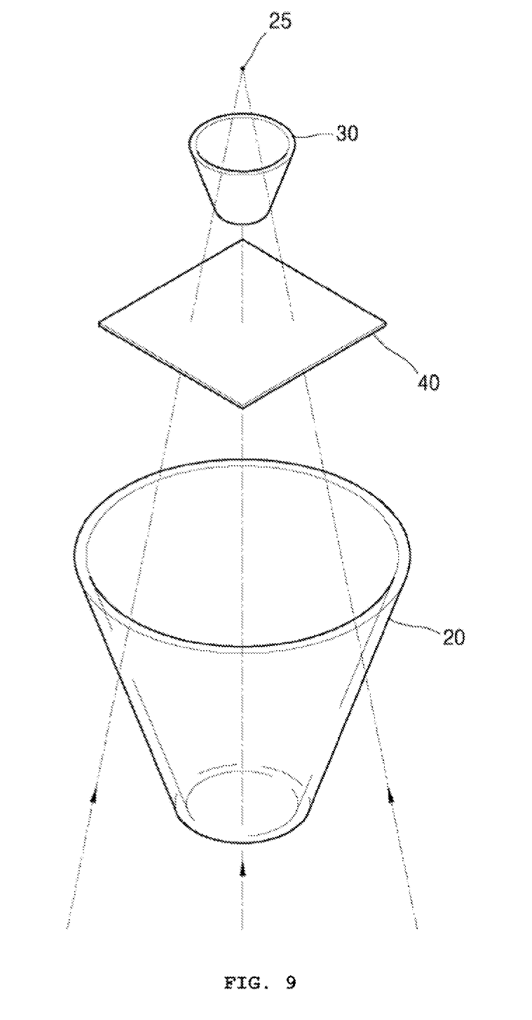

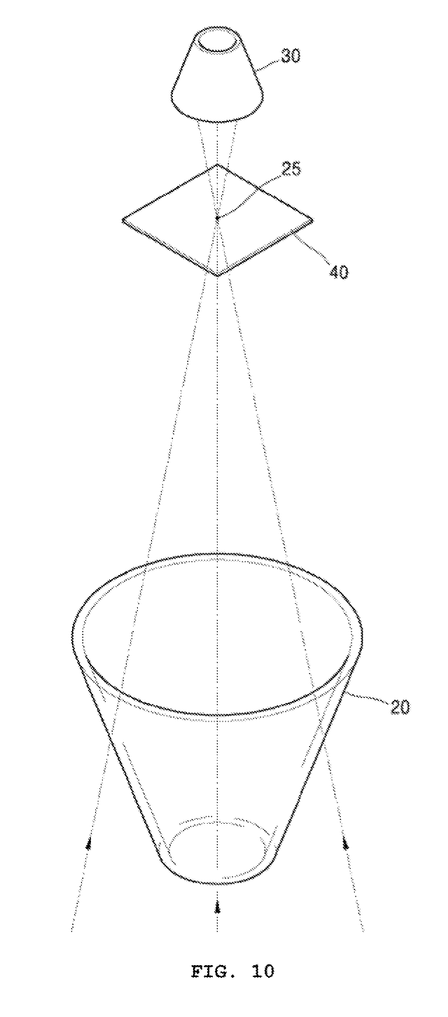

FIG. 3 is a view showing an example of an arrangement of a lens and an image sensor in a camera according to a first embodiment of the present disclosure. FIG. 4 is a view seen in a “Z” direction shown in FIG. 3. FIG. 5 is a sectional view taken along line V-V in FIG. 3. FIG. 6 is a view showing a modified structure of the first embodiment. FIG. 7 is a view showing an arrangement of an image sensor in a camera structure according to a second embodiment of the present disclosure. FIG. 8 is a plan view of the camera structure shown in FIG. 7. FIG. 9 is a view showing an arrangement of an image sensor in a camera structure according to a third embodiment of the present disclosure. FIG. 10 is a view showing a modified structure of the third embodiment.

In the figures, a virtual line arrow indicates a direction in which light passes through a lens and enters an image sensor.

Hereinafter, the structure and effects of the lens will be described in the course of describing the structure and effects of a wide view angle camera including a wide view angle lens according to the present disclosure.

Referring to FIGS. 3 to 10, a camera capable of photographing in a wide view angle according to embodiments of the present disclosure includes a lens 20 and an image sensor 30.

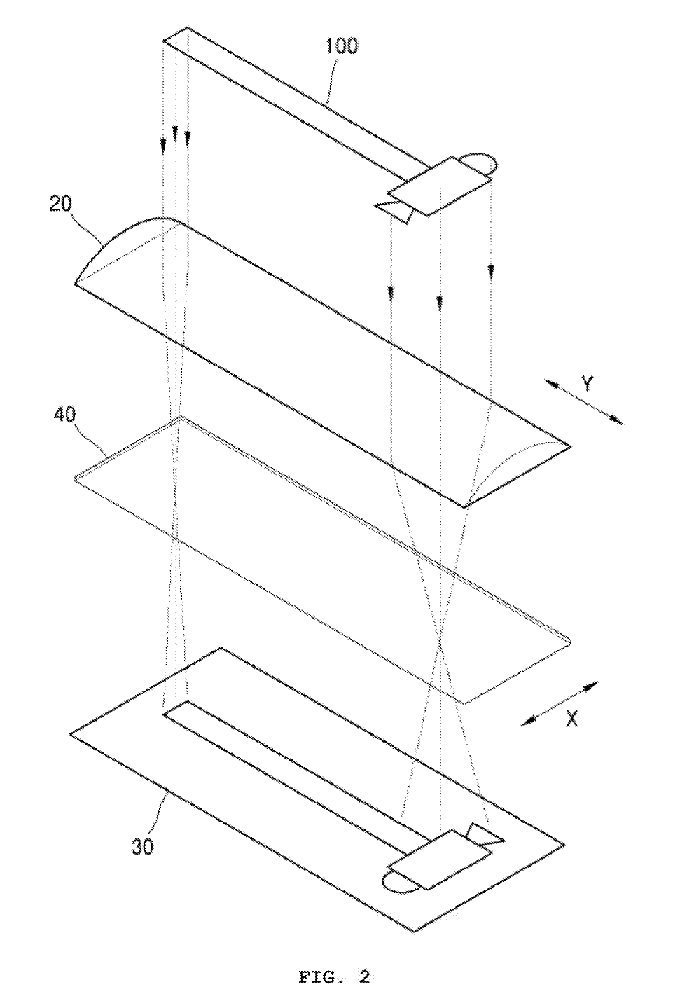

The lens 20 is a component that serves to condense light reflected from a subject 100. The lens 20 used in the present disclosure is obtained by processing a rod-shaped convex lens again. An example of a rod-shaped convex lens includes a cylinder lens. In general, a cylinder lens is a lens of a type in which X axis and Y axis radii are different from each other. The cylinder lens 200 is formed in a semi-cylindrical shape, for example, as shown in FIG. 2. Meanwhile, the cylinder lens 200 may be manufactured in a cylindrical shape. The cylinder lens forms a focused image along one line rather than forming a focused image based on a single point. Generally, since the cylinder lens has a curved face only in one axial direction and does not have a curved face in another axial direction, light is condensed only in the one axial direction. Therefore, the cylinder lens 200 shown in FIG. 2 forms a linear image in the Y-axis direction. The principle in which the light reflected from a subject 100 passes through the cylinder lens and forms an image on the image sensor 30 can be easily understood with reference to FIG. 2. Referring to FIG. 2, an image of the subject 100 is symmetrically changed in the left-right direction X when passing through the cylinder lens, and then passing through a diaphragm 40 so as to be formed in the image sensor 30. Meanwhile, when the image of the subject 100, which has passed through the cylinder lens, is formed on the image sensor 30, the image of the subject 100 is not symmetrically changed in the longitudinal direction Y.

In the present disclosure, such a rod-shaped convex lens is processed to be bent once again such that curved faces are formed in both the X and Y-axis directions, so that an undistorted image can be formed so as to be focused and a reduced image for a large object can be formed in the camera. That is, the lens 20 is processed such that the trace of the focal distance D forming the focused image is formed in a curve. Accordingly, the lens 20 forms a structure bent with a curvature equal to the curvature of the curve formed by the trace of the focal distance D. In the present disclosure, the lens 20 is a constituent element acting as a pinhole in principle of a camera. In particular, while a conventional lens forms an image at one focal point, the lens 20 employed in the present disclosure is characterized in that it is configured to form an image on a curve. That is, in the present disclosure, the lens 20 functions like a slit-shaped pinhole in the camera principle. Therefore, the lens 20 functions to form a wide view angle image without distortion at the focal length D formed on the curve. That is, the lens 20 simultaneously performs the role of a slit-shaped pinhole and the unique role as a lens for condensing light.

In addition, since the lens 20 has a structure bent with a constant curvature in the Y direction, there is a spherical center 25 according to the curvature of the lens 20 in the Y direction. When the image sensor 30, which will be described later, is positioned in front of the spherical center 25 with respect to the center of the lens 20, an image in the Y direction does not change symmetrically with the actual object. Meanwhile, when the image sensor 30 is positioned behind the spherical center 25 as shown in FIGS. 6 and 10, an image in the Y direction changes symmetrically with the actual object.

For example, the lens 20 may be a convex lens having all the types of continuous focuses that are generated by drawing a line segment with respect to an imaginary axis in space and rotating the line segment with respect to the axis. The line segment may be a straight line or a part of a curve.

The focal length D defined in the present disclosure means a trace of a position in which a subject in the depth of field of the lens is focused. Therefore, the focal length D has the value of a distance between the lens 20 and the spherical center 25 minus a or a distance between the lens 20 and the spherical center 25 plus a.

Also, since the lens 20 has a structure bent with a constant curvature in the Y direction, the size of the image formed on the image sensor 30 may be smaller than the size of the actual object.

The image sensor 30 is arranged to correspond to the focal length D of the lens 20. The image sensor 30 outputs a clear image formed by light passing through the lens 20 as an electric signal. The electric signal of the image sensor 30 may be current or voltage. As the image sensor 30, a CCD sensor or a CMOS sensor may be employed. The image sensor 30 is formed to have a curved face to correspond to the focal length D of the lens 20. The image sensor 30 may be formed by attaching an image sensor having a fine size onto a curved member. Meanwhile, the image sensor 30 may be directly laminated on a CCD or CMOS circuit by applying a continuous semiconductor manufacturing process to the surface of a curved member. A manufacturing process of the image sensor 30 may be configured by applying a known semiconductor manufacturing process.

As described above, since the structure corresponding to the focal distance D of the lens 20 is configured to be formed in a curved shape and the image sensor 30 is configured in a curved shape corresponding a face corresponding to the focal distance D of the lens 20, an image formed on the image sensor 30 is not distorted compared with the actual image. Further, the lens 20 is processed to be bent into a curved shape, thereby widening the area where light is condensed on the lens 20, which enables wide view angle photographing.

A shutter film (not shown) may be disposed between the lens 20 and the image sensor 30. As the shutter film, a known shutter film structure may be employed. The shutter film may have a flat or curved shape.

A diaphragm (or iris or iris diaphragm) 40 may be disposed between the lens 20 and the image sensor 30. The diaphragm 40 functions to adjust the amount of light passing through the lens 20. The diaphragm 40 may employ a known iris structure of a camera. Meanwhile, the diaphragm 40 may be disposed in front of the lens 20.

The lens 20, the image sensor 30, the shutter film, and the diaphragm 40 may be disposed inside a frame (not shown) so as to form a camera.

Cameras according to the first embodiment, which are shown in FIGS. 3 to 5, include a lens 20 obtained by processing a rod-like convex lens to be bent with the same curvature with respect to one axis. The one axis means an imaginary axis, for example, a virtual axis passing vertically through the paper plane at the spherical center 25 in FIG. 4. More specifically, the camera is configured such that the lens 20 is bent to have a constant curvature in the Y direction. Further, the image sensor 30 is disposed in front of the spherical center 25 generated by the curvature of the lens 20 in the Y direction. Accordingly, an image formed on the image sensor 30 forms an image of the same shape as the actual object in the Y direction. The lens 20 may be processed to have an angle of view θ of, for example, about 120° so as to be suitable for an angle to be photographed. That is, the lens 20 may be obtained by forming a rod-shaped convex lens in the shape of a part of a cylindrical shape with respect to one axis.

Meanwhile, in a modified structure of the first embodiment shown in FIG. 6, the image sensor 30 is arranged behind the spherical center 25 generated by the Y-directional curvature of the lens 20. Accordingly, in the structure shown in FIG. 6, an image formed on the image sensor 30 is formed in a symmetrical shape in the Y direction with respect to the actual object thereof.

Meanwhile, the lens 20 constituting the camera according to a second embodiment shown in FIGS. 7 and 8 may be processed in a cylindrical structure so as to photograph an angle of view of 360° with respect to one axis. In this case, the structure of the image sensor 30 is also formed in a cylindrical structure like the lens 20. That is, the lens 20 may have a rod-shaped convex lens having a cylindrical structure with respect to one axis.

Meanwhile, a lens 20 constituting a camera according to a third embodiment shown in FIG. 9 may be processed into a truncated conical structure with respect to one axis. In this case, the structure of the image sensor 30 is also formed into a truncated conical structure like the lens 20. When the lens 20 is processed into the truncated conical structure shown in FIG. 9, the angle of view θ of the lens 20 can be further widened. In particular, a camera structure similar to that of the third embodiment shown in FIG. 9 is suitable for a CCTV camera installed on the ceiling of a building.

Meanwhile, the camera shown in FIG. 10 has a modified structure of the camera shown in FIG. 9. That is, the image sensor 30 is disposed behind the spherical center 25 generated by the Y-directional curvature of the lens 20. Accordingly, in the structure shown in FIG. 10, an image formed on the image sensor 30 is formed in a symmetrical shape in the Y direction with respect to the actual object thereof. Thus, the lens 20 may be manufactured in a truncated conical structure or a structure corresponding to a part of the truncated conical structure with respect to one axis using a rod-shaped convex lens.

Hereinafter, acting effects of a wide view angle lens including the above-described components and a wide view angle camera including the lens will be described in detail.

First, the subject 100 reflects light from a light source such as sunlight or a lamp. The light reflected from the subject 100 passes through the lens 20. Since the lens 20 is bent with respect to one axis, a focused image is formed on a curved face. Since the image sensor 30 is disposed on a curved face corresponding to the focal length D of the lens 20, an image formed through the lens 20 is formed on the image sensor 30 without being distorted. The image sensor 30 outputs the formed image signal as an electric signal. The electric signal output from the image sensor 30 is converted into a form of an image visible to a human in an image processing module and the image is output to a monitor or a recording medium. That is, an essential feature of the present disclosure is that an image focused by the lens 20 is formed on a curved face, and the image sensor 30 is disposed at a position corresponding to the curved face, so that a distortion-free image can be obtained. In addition, the lens 20 has an advantage in that it can be bent and processed into a face curved as much as necessary, so that it is possible to very easily implement required wide view angle photographing.

As described above, according to a camera structure of the present disclosure, a structure corresponding to a focal length of a lens forming an image is formed on a curved face, and an image sensor corresponding to the curved face is provided. Accordingly, there is provided an effect of providing a camera capable of implementing wide view angle photographing in an innovative manner.

In addition, the camera structure according to the present disclosure is capable of obtaining a wide-angle image that is not distorted even when a lens group, which is constituted with a plurality of conventional lens having a complicated structure, is not employed by processing a rod-shaped convex lens into a curved face with respect to one axis. Thus, it is possible to reduce the manufacturing cost of a camera, thereby providing a very advantageous effect to manufacturers and consumers in terms of economy.

While the present disclosure has been described with reference to embodiments, it is to be understood that the present disclosure is not to be limited by such embodiments, and various changes and modifications may be made without departing from the technical idea of the present disclosure.

### MODE FOR CARRYING OUT THE INVENTION

In order to achieve the above-described objective, a wide view angle lens according to an embodiment of the present disclosure is a wide view angle lens configured to condense light from a subject.

The lens is a convex lens having all types of continuous focal points formed by drawing a line segment with respect to one axis and rotating the line segment with respect to the axis.

Meanwhile, in order to achieve the above-described objective, a wide view angle lens according to an embodiment of the present disclosure includes a lens configured to condense light from a subject, and an image sensor disposed at a focal length of the lens and configured to output an image of light passing through the lens as an electric signal.

The lens is a convex lens having all types of continuous focal points formed by drawing a line segment with respect to one axis and rotating the line segment with respect to the axis, and the image sensor is formed in a curved shape so as to correspond to the focal length of the lens.

The lens may be manufactured by bending a rod-shaped convex lens into any one of a cylindrical shape, a part of the cylindrical shape, a truncated conical shape, and a part of the truncated conical shape with respect to one axis.

1. A wide view angle lens for condensing light from a subject,
wherein the lens is a convex lens having all types of continuous focal points formed by drawing a line segment with respect to one axis and rotating the line segment with respect to the axis,
wherein the lens is processed in such a manner that a rod-shaped convex lens is processed again to be bent again such that a trace of a focal length forming a focused image is formed as a curve, and
wherein the lens forms a structure bent with a same curvature as a curvature of the curve formed by the trace of the focal length.

2. A wide view angle camera comprising:
a lens configured to condense light from a subject; and
an image sensor disposed at a focal length of the lens and configured to output an image of light passing through the lens as an electric signal,
wherein the lens is a convex lens having all types of continuous focal points formed by drawing a line segment with respect to one axis and rotating the line segment with respect to the axis,
wherein the lens is processed in such a manner that a rod-shaped convex lens is processed again to be bent again such that a trace of a focal length forming a focused image is formed as a curve,
wherein the lens forms a structure bent with a same curvature as a curvature of the curve formed by the trace of the focal length, and
wherein the image sensor is formed in a curved shape so as to correspond to the focal length of the lens.

3. The wide view angle camera of claim 2, wherein the lens is manufactured by bending a rod-shaped convex lens into any one of a cylindrical shape, a part of the cylindrical shape, a truncated conical shape, and a part of the truncated conical shape with respect to one axis.
